(19) United States
(12) Patent Application Publication
(10) Pub. No.: US 2008/0301985 A1
(43) Pub. Date: Dec. 11, 2008

(54) ROCKING HEAD PICTURE DISPLAY DEVICE

(76) Inventor: Chien-Hsun Tsao, Sinjhuang City (TW)

Correspondence Address: Connolly Bove Lodge & Hutz, LLP, P.O. Box 2207, Wilmington, DE, 19899-2207, US

(21) Appl. No.: 11/758,071

(22) Filed: Jun. 5, 2007

(51) Int. Cl. G09F 19/08; G09F 19/02

(52) U.S. Cl. 40/423

(57) ABSTRACT

A rocking head picture display device includes a hollow casing with a bottom and a rocking assembly received in the casing. The rocking device includes a drive element mounted on the bottom of the casing and a rocking device mounted on a top of the casing. The rocking device corresponds to the drive element. The rocking device includes a pivot sequentially extending through the casing and a rocking shaft that linearly corresponds to the drive element. A connector is connected to one end of the pivot relative to a front side of the casing. A seat is upwardly mounted to a bottom of the casing. A picture is divided into a head-style portion adhered to the connector and a body-style portion located between the seat and the casing.

### BACKGROUND OF THE INVENTION

1. Field of the Invention

The present invention relates to a picture display device, and more particularly to a rocking head picture display device.

2. Description of Related Art

Taking picture is wonderful experience in daily life and during a journey. Traditionally, people use picture frames to display their lovely photos. However, it still seems not enough to just statically show pictures in this way because of lacking fun. Life is bored. If we can change something we get used to in different presentation, our life may be filled and full with varieties and amusement. Photo display is exactly one of the examples.

A conventional rocking head picture display device in accordance with the prior art shown in FIG. 1 comprises a rocking device (1) and a picture (2) attached to the rocking device (1). The rocking device (1) includes a body (12) and a rocking element (11) pivotally mounted in the rocking device (1) and extending through a top of the rocking device (1). The rocking element (11) has a free end rocked relative to the rocking device (1) due to an electromagnetic element (not shown) when energy is provided to the rocking device (1). A connector (13) is attached to the free end of the rocking element (11). The picture (2) is divided into a body-style portion (21) adhered to the body (12) of the rocking device (1) and a head-style portion (22) adhered to the connector (13) such that the body-style portion (21) is parallel to the head-style portion (22). As a result, the head-style portion (22) is rocked relative to the body-style portion (21) when the rocking device (1) is operated.

However, the connector (13) is attached to the free end of the rocking element (11) such that the rocking element (11) is easily broken when being packaged or during transporting. In addition, the body-style portion (21) and the head-style portion (22) are respectively adhered to the body (12) of the rocking device (1) and the connector (13) such that the body-style portion (21) and the head-style portion (22) are difficult to be detached from the rocking device (1) and replaced.

The present invention has arisen to mitigate and/or obviate the disadvantages of the conventional rocking head picture display device.

### SUMMARY OF THE INVENTION

The main objective of the present invention is to provide an improved rocking head picture display device that is a convenient design and makes the picture more vivid.

To achieve the objective, the picture display device in accordance with the present invention comprises a hollow casing with a bottom and a rocking assembly received in the casing. The rocking device includes a drive element mounted on the bottom of the casing and a rocking device mounted on a top of the casing. The rocking device corresponds to the drive element. The rocking device includes a pivot sequentially extending through the casing and a rocking shaft that linearly corresponds to the drive element. A connector is connected to one end of the pivot relative to a front side of the casing. A seat is upwardly mounted to a bottom of the casing. A picture is divided into a head-style portion adhered to the connector and a body-style portion located between the seat and the casing.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional rocking head picture display device in accordance with the prior art;

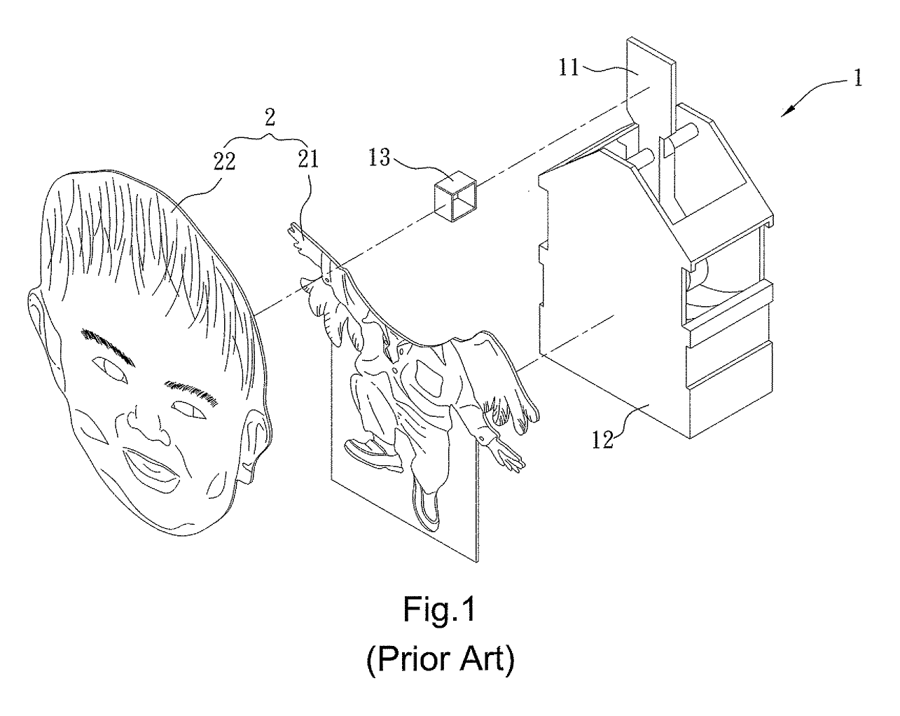

FIG. 2 is a perspective view of a rocking head picture display device in accordance with the present invention;

FIG. 3 is a side cross-sectional view of the rocking head picture display device in FIG. 2;

FIG. 4 is an exploded perspective view of the rocking head picture display device in FIG. 2;

FIG. 5 is a second exploded perspective view of the rocking head picture display device in FIG. 2 for showing a seat mounted to a casing of the present invention;

FIG. 6 is a third exploded perspective view of the rocking head picture display device in FIG. 2 for showing the seat and a connector respectively mounted to the casing of the present invention;

FIG. 7 is a perspective view of a second embodiment of the rocking head picture display device in accordance with the present invention; and

FIG. 8 is a perspective operational view of the rocking head picture display device in accordance with the present invention.

### DETAILED DESCRIPTION OF THE INVENTION

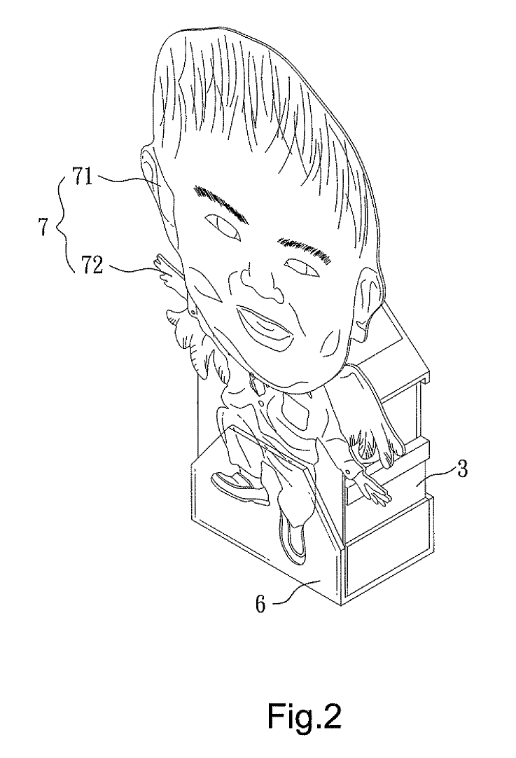

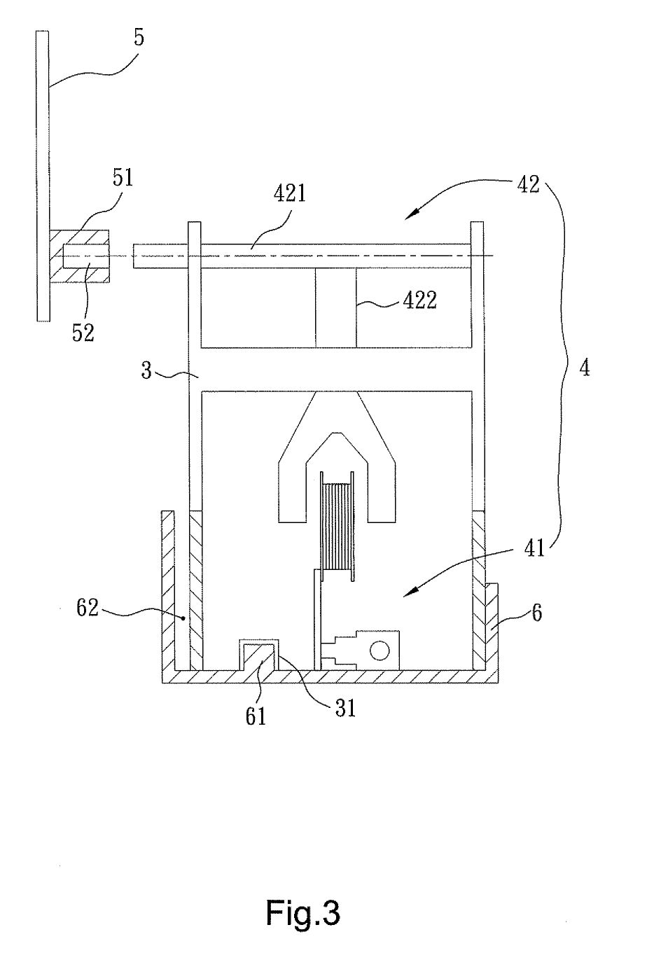

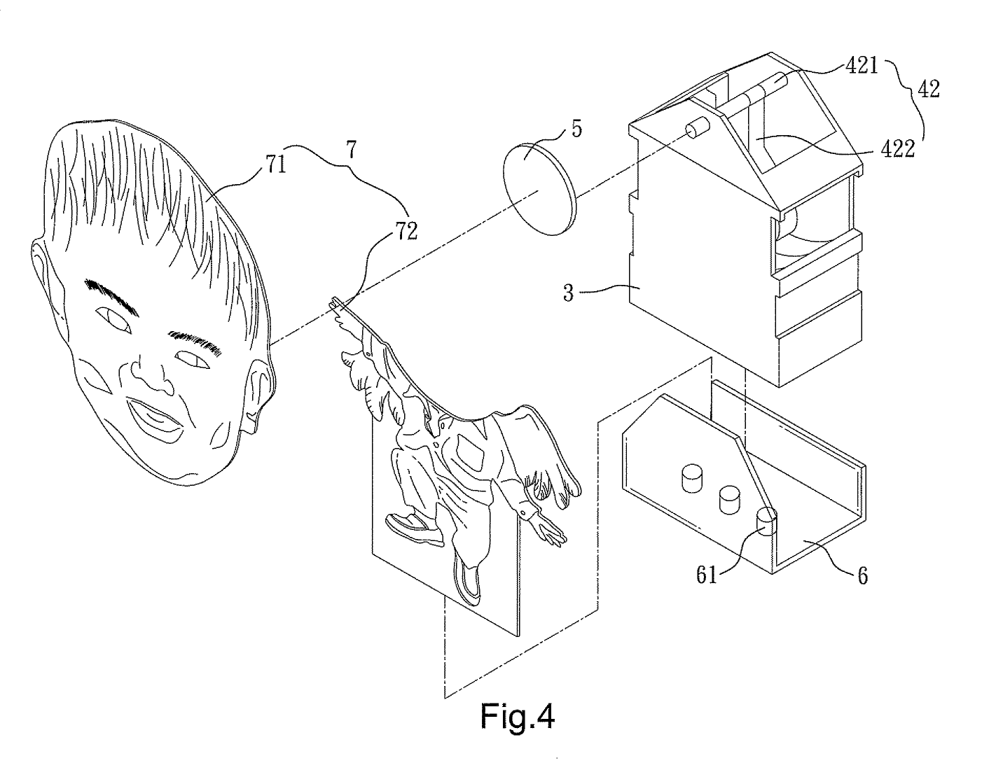

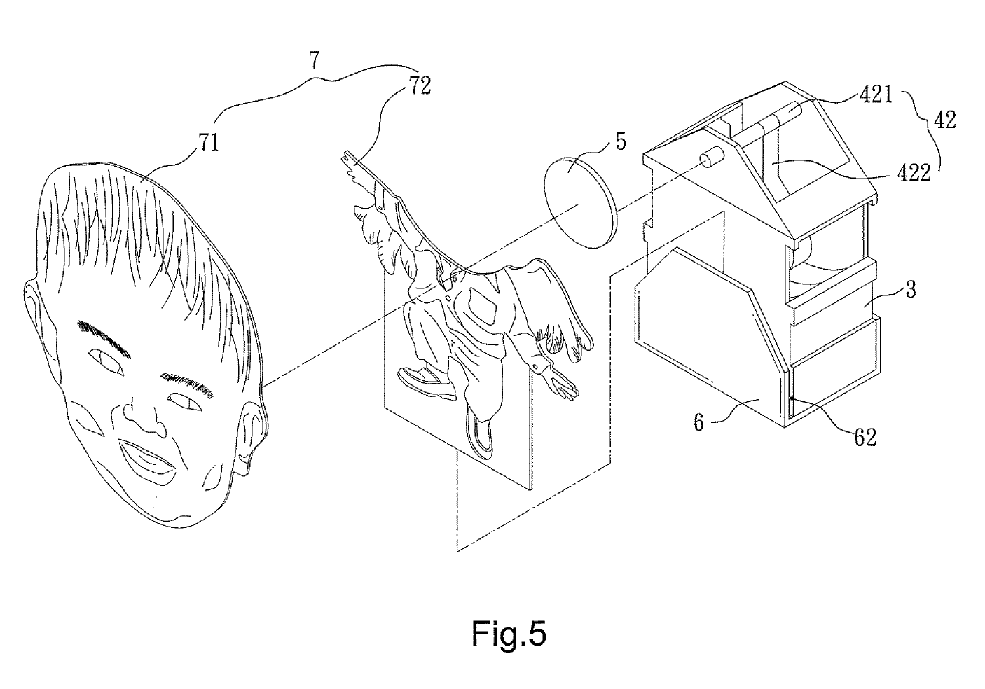

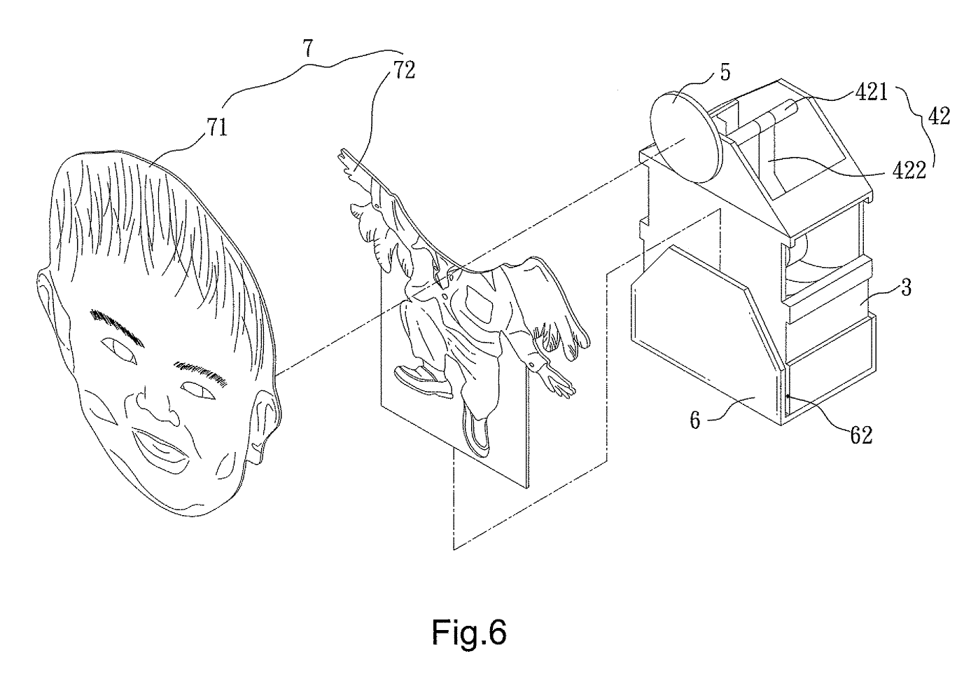

Referring to the drawings and initially to FIGS. 2-6, a rocking head picture display device in accordance with the present invention comprises hollow casing (3), a rocking assembly (4) received in the casing (3), a connector (5) detachably connected to the rocking assembly (4), a seat (6) upwardly mounted to a bottom of the casing (3), and a picture (7) respectively connected to the seat (6) and the connector (5).

The casing (3) has a bottom with multiple through holes (31) defined in the bottom of the casing (3).

The rocking assembly (4) includes a drive element (4 1) mounted on the bottom of the casing (3) and a rocking device (42) mounted on the top of the casing (3). The rocking device (42) corresponds to the drive element (41). In the preferred embodiment of the present invention, the drive element (41) is an electromagnetic element. The rocking device (42) includes a pivot (421) sequentially extending through the casing (3) and a rocking shaft (422) that linearly corresponds to the drive element (41). The rocking shaft (422) has a magnetic induction relative to the drive element (41). The pivot (421) has an operational end (not numbered) extending to a S front side of the casing (3).

The connector (5) is connected to the operational end of the pivot (421). The connector (5) has a stub (51) eccentrically extending from a back thereof to magnify a rock range of the connector (5). The stub (51) has a bore (52) defined therein for receiving the operational end of the pivot (421).

The seat (6) is made of transparent material, and has a bottom and a U-shaped cross section. The seat (6) includes multiple protrusions (61) upwardly extending from the bottom of the seat (6). Each protrusion (61) extends through a corresponding one of the through holes (31) of the casing (3) to hole the seat (6) in place when the seat (6) connected to the casing (3). A slot (62) is defined between the front side and the seat (6) after the seat (6) connected to the bottom of the casing (3).

The picture (7) is divided into a head-style portion (71) attached to the connector (5) and a body-style portion (72) inserted into the slot (62) between the seat (6) and the casing (3).

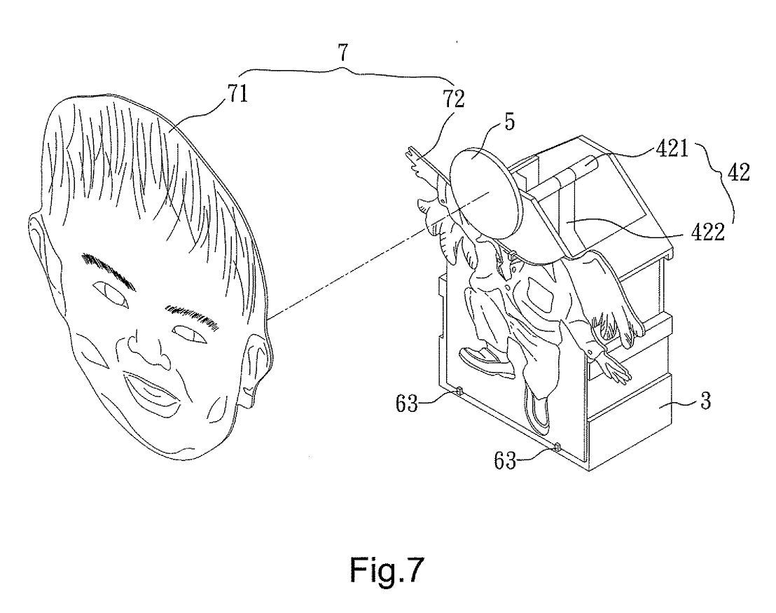

With reference to FIG. 7 that shows a second embodiment of the picture display device in accordance with the present invention, a front side of the seat (6) is cut out and the seat (6) has multiple hooks (63) extending from the bottom of the seat (6) for engaging a lower side of the body-style portion (72) of the picture (7).

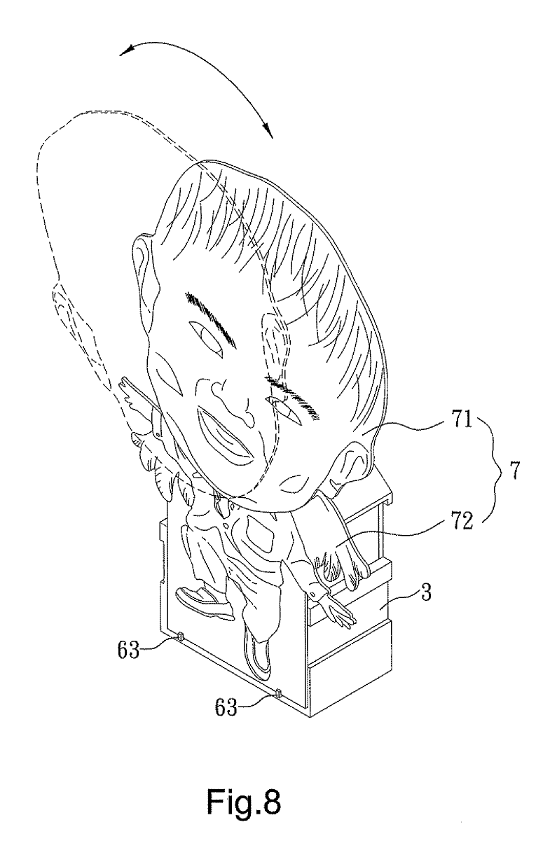

With reference to FIG. 8, the drive element (41) drives the rocking device (42) with the connector (5) when energy is provided to the drive element (41). As a result, the head-style portion (71) is rocked relative to the body-style portion (72) because the head-style portion (71) is attached to the connector (5).

As described above, the rocking head picture display device in accordance with the present invention has several advantages as follow.
1. The connector (5) can be easily detached from the operational end of the pivot (421) such that the rocking device (42) and the connector (5) would not be broken when being packaged or during transporting.
2. The body-style portion (72) can be easily detached from the seat (6) and replaced as user's purpose. This is a convenient design and makes the picture (7) more vivid.

Although the invention has been explained in relation to its preferred embodiment, it is to be understood that many other possible modifications and variations can be made without departing from the spirit and scope of the invention as hereinafter claimed.

1. A rocking head picture display device comprising:
a rectangular hollow casing;
a rocking assembly, which is received in the casing including a drive element mounted to a bottom of the casing and a rocking device mounted to a front side and a rear side of the casing near a top of the casing, wherein, the rocking device further includes a pivot transversely piercing the casing and a rocking shaft extending downward from the pivot to correspond to the drive element;
a plate-shaped connector connected to the pivot and disposed next to the front side of the casing;
a seat with a U-shaped cross-section upwardly mounted to the bottom of the casing; and
a picture divided into a head-style portion adhered to the connector and a body-style portion located between the seat and the casing;
wherein, an end of pivot extends through the front side of the casing and a stub extends eccentrically outward the connector transversely to fit with the end;
and the seat has a U-shaped cross section with a lateral side thereof spacing apart from the front side a distance to form a slot for locating the body-style portion.

2. The picture display device as claimed in claim 1, wherein the stub has a bore for fitting with the end of the pivot.

3. The picture display device as claimed in claim 1, wherein the stub extends from a back side of the connector to magnify a rock range of the connector.

4. (canceled)

5. The picture display device as claimed in claim 1, wherein the slot partially receives the body-style portion.

6. The picture display device as claimed in claim 1, wherein a plurality of protrusions upwardly extending from the bottom of the seat and a plurality of locating holes provided at the bottom of the casing corresponding to the protrusions such that the protrusions fit with the locating holes.

7-9. (canceled)

10. The picture display device as claimed in claim 1, wherein the drive element is an electromagnetic element.

11. A rocking head picture display device comprising:
a hollow casing;
a rocking assembly, which is received in the casing, including a drive element mounted to a bottom of the casing and a rocking device mounted to a front side and a rear side of the casing near a top of the casing, wherein the rocking device further includes a pivot piercing the casing transversely and a rocking shaft extending downward from the pivot to correspond to the drive element; the plate-shaped connector is connected to the pivot and disposed next to the front side of the casing; and
a plate-shaped connector connected to the pivot and disposed next to a front side of the casing; and
a picture divided into a head-style portion adhered to the connector and a body-style portion located at the front side of the casing;
wherein, an end of the pivot extends through the front side and a stub extends eccentrically outward the connector transversely to fit with the end; and
a plurality of hooks are arranged at the bottom of the front side for holding the lower side of the body-style portion.

12. The picture display device as claimed in claim 11, wherein the stub has a bore for fitting with the end of the pivot.

13. The picture display device as claimed in claim 11, wherein the stub extends from a back side of the connector to magnify a rock range of the connector.

14. The picture display device as claimed in claim 1, wherein the drive element is an electromagnetic element.
